(19) United States
(12) Patent Application Publication
(10) Pub. No.: US 2026/0264600 A1
(43) Pub. Date: Sep. 10, 2026

(54) LAMP CONTROL SYSTEM FOR VEHICLE AND METHOD OF CONTROLLING THE SAME

(71) Applicant: HYUNDAI MOBIS CO., LTD., Seoul (KR)

(72) Inventors: Jung Sub LIM, Yongin-si (KR); Ki Dong LEE, Yongin-si (KR)

(73) Assignee: HYUNDAI MOBIS CO., LTD., Seoul (KR)

(21) Appl. No.: 19/456,390

(22) Filed: Jan. 22, 2026

(30) Foreign Application Priority Data
Mar. 7, 2025 (KR) 10-2025-0030014
Apr. 14, 2025 (KR) 10-2025-0047800

(51) Int. Cl. B60Q 1/08; B60Q 1/00; B60Q 1/14; B60Q 1/16

(52) U.S. Cl. CPC B60Q 1/08; B60Q 1/0023; B60Q 1/143; B60Q 1/16; B60Q 2300/054; B60Q 2300/322; B60Q 2300/331; B60Q 2300/42

(57) ABSTRACT

A lamp control system for a vehicle includes an image input unit to receive forward image data of the vehicle from a camera sensor and an image analysis unit to analyze the forward image data of the vehicle using an image processing algorithm and, when a determined road type begins with a right curved road at a long distance ahead of the vehicle, generate lighting pattern information to control a vehicle lamp. The vehicle lamp includes a plurality of light sources, and each of the light sources has at least one of a light-emitting position and light intensity controlled according to the lighting pattern information.

### CROSS-REFERENCE TO RELATED APPLICATIONS

The present application claims priority to Korean Patent Application No. 10-2025-0030014, filed Mar. 7, 2025, and Korean Patent Application No. 10-2025-0047800, filed Apr. 14, 2025, the entire contents of which is incorporated herein for all purposes by this reference.

### BACKGROUND

### Field of the Invention

The present invention relates to a lamp control system for a vehicle and a method of controlling the same, and more specifically, to a lamp control system for a vehicle and a method of controlling the same, which may provide a driver of a host vehicle with maximum visibility and minimize glare to oncoming lanes when a right-hand curved road begins at a distant point ahead of the host vehicle while driving.

### Description of the Related Art

Vehicle headlights are essential components for nighttime driving. Conventional headlights have only a simple on/off function, but headlights are gradually evolving to provide drivers with maximum nighttime visibility.

Representative functions of such headlight include high beams and low beams.

The high beams project strong beams at a relatively high angle to provide long-range illumination to the driver, providing convenience to the driver of the host driver, but have a disadvantage of causing glare to drivers of preceding or oncoming vehicles.

Accordingly, the operation of controlling the on/off of high beams based on driving conditions is required, and such an operation can reduce driver concentration, and thus high beam assistance (HBA), which is a technology for automatically turning on and off high beams, has been developed.

The HBA is a technology of analyzing image data from a forward camera mounted on a vehicle and automatically turning off high beams when other road users (preceding or oncoming vehicles) are recognized. The HBA is effective technology but has a disadvantage in which the high beams are turned off when there is even a single vehicle on the road and in environments in which vehicles appear sporadically, the high beams are turned on and off repeatedly, or their functions are limited.

To address such a disadvantage, an adaptive driving beam (ADB) has been developed. The ADB divides an emitting range of the high beams into multiple segments and controls the segments individually. That is, by partially turning off the high beams only in the area of other vehicles recognized, the ADB provides the driver of the host vehicle with maximum nighttime illumination. In this way, it is apparent that the ADB provides a better lighting environment than the HBA. However, the ADB typically has 10 to 100 segments, each of which has a relatively large beam area, and thus has an increased lighting time compared to the HBA, but the relatively large beam area makes precise beam control difficult for various driving environments.

Accordingly, a high-definition adaptive driving beam (HD-ADB) technology has recently been developed.

The HD-ADB is based on a system with a beam control resolution 10 times or more that of the conventional ADB. Typically, the HD-ADB has segments with 10K pixels or more, and an HD-ADB system is rapidly being installed, particularly in the European automotive industry.

Accordingly, based on the HD-ADB, it is necessary to further classify driving environments and apply precise lighting control methods optimized for each situation.

In this regard, Korean Patent Registration No. 10-1325791 (“vehicle headlight control device and control method thereof”) discloses a technology for recognizing lanes in a road image and controlling an angle of headlights installed in a vehicle based on a curvature of the recognized lanes.

### SUMMARY

The present invention relates to a lamp control system for a vehicle and a method of controlling the same, which can minimize glare to oncoming lanes when a right-hand curved road begins at a distant point ahead of a vehicle while traveling in a right-hand traffic area and precisely control a light-emitting state of high beams to provide maximum illumination to a driver of a host vehicle.

According to the present invention, there is provided lamp control system for a vehicle, including an image input unit configured to receive forward image data of the vehicle from a camera sensor, and an image analysis unit configured to analyze the forward image data of the vehicle using an image processing algorithm and, when a determined road type begins with a right curved road at a long distance ahead of the vehicle, generate lighting pattern information to control a vehicle lamp, wherein the vehicle lamp includes a plurality of light sources, each of the light sources has at least one of a light-emitting position and light intensity controlled according to the lighting pattern information.

The image analysis unit may include a boundary line setting unit configured to analyze the forward image data of the vehicle to set a right boundary line of a lane, a point recognition unit configured to recognize a maximum visibility point of the set right boundary line, a road surface setting unit configured to analyze the forward image data of the vehicle to set a road surface boundary line, and a pattern generation unit configured to generate the lighting pattern information using the right boundary line, the maximum visibility point, and the road surface boundary line.

The boundary line setting unit may further include a first setting unit configured to analyze the forward image data of the vehicle and, when a predetermined object is recognized, set the corresponding predetermined object as the right boundary line, and a second setting unit configured to analyze the forward image data of the vehicle and, when the predetermined object is not recognized, generate a virtual boundary line outward from a right side of the recognized lane line and set the generated virtual boundary line as the right boundary line.

The point recognition unit may be configured to recognize a maximum point of the right boundary line along a y-axis as the maximum visibility point using position coordinates of the right boundary line set in the boundary line setting operation.

The pattern generation unit may set an area from the road surface boundary line to a predetermined height as a first control zone, set an area from the first control zone to an end point along a y-axis as a second control zone, set a predetermined range around the maximum visibility point as a third control zone, and generate the lighting pattern information to control at least one of light-emitting positions and luminous intensities of each light source corresponding to each control zone.

The pattern generation unit may generate the lighting pattern information so that the corresponding light source is selectively turned on or off depending on the presence of an oncoming vehicle with respect to the first control zone, generate the lighting pattern information so that the corresponding light source is turned off with respect to the second control zone, and generate the lighting pattern information so that a luminous intensity of the light source corresponding to the maximum visibility point is highest and gradually decreases toward a periphery compared to the luminous intensity of the maximum visibility point with respect to the third control zone.

A method of controlling a vehicle lamp, in which each operation is performed by a computational processing unit includes an image input operation (S100) of receiving forward image data of a vehicle from a camera sensor, and an image analysis operation (S200) of analyzing the forward image data of the vehicle received in the image input operation (S100) using an image processing algorithm and, when a determined road type begins with a right curved road at a long distance ahead of the vehicle, generating lighting pattern information to control the vehicle lamp.

The image analysis operation (S200) may include when a determined road type begins with a right curved road at a long distance ahead of the vehicle as a result of analyzing the forward image data of the vehicle received in the image input operation (S100), a boundary line setting operation (S210) of analyzing the forward image data of the vehicle to set a right boundary line of a lane, a point recognition operation (S220) of recognizing a maximum visibility point of the right boundary line set in the boundary line setting operation (S210), a road surface setting operation (S230) of setting a road surface boundary line by analyzing the forward image data of the vehicle received in the image input operation (S100), and a pattern generation operation (S240) of generating the lighting pattern information using the right boundary line, the maximum visibility point, and the road surface boundary line.

The boundary line setting operation (S210) may include analyzing the forward image data of the vehicle and, when a predetermined object is recognized, setting the corresponding predetermined object as the right boundary line.

The boundary line setting operation (S210) may include analyzing the forward image data of the vehicle and, when a predetermined object is not recognized, generating a virtual boundary line outward from a right side of the recognized lane line, and setting the generated virtual boundary line as the right boundary line.

The point recognition operation (S220) may include recognizing a maximum point of the right boundary line along a y-axis as the maximum visibility point using position coordinates of the right boundary line set in the boundary line setting operation.

The image generation operation (S240) may further include a first generation operation (S241) of setting an area from the road surface boundary line to a predetermined height as a first control zone, a second generation operation (S242) of setting an area from the first control zone to an end point along a y-axis as a second control zone, a third generation operation (S243) of setting a predetermined range around the maximum visibility point as a third control zone, the vehicle lamp may include a plurality of light sources, and each light source corresponding to each control zone may have at least one of a light-emitting position and light intensity controlled according to the lighting pattern information.

The image generation operation (S240) may further include generating the lighting pattern information so that the corresponding light source is selectively turned on or off depending on the presence of an oncoming vehicle with respect to the first control zone, generating the lighting pattern information so that the corresponding light source is turned off with respect to the second control zone, and generating the lighting pattern information so that a luminous intensity of the light source corresponding to the maximum visibility point is highest and gradually decreases toward a periphery compared to the luminous intensity of the maximum visibility point with respect to the third control zone.

### BRIEF DESCRIPTION OF THE DRAWINGS

FIGS. 1A, 1B and 1C are exemplary view illustrating a headlight control state of a conventional lamp control system for a vehicle and a lamp control system for a vehicle according to an embodiment of the present invention.

FIG. 2 is an exemplary view illustrating a configuration of the lamp control system for a vehicle according to the embodiment of the present invention.

FIG. 3 is an exemplary view illustrating a process of setting a right boundary line of a lane in the lamp control system for a vehicle and a method of controlling the same according to the embodiment of the present invention.

FIG. 4 is an exemplary view illustrating a process of recognizing a maximum visibility point of a right boundary line in the lamp control system for a vehicle and the method of controlling the same according to the embodiment of the present invention.

FIG. 5 is an exemplary view illustrating lighting pattern information divided into each control zone in the lamp control system for a vehicle and the method of controlling the same according to the embodiment of the present invention.

FIG. 6 is an exemplary flowchart illustrating a method of controlling a vehicle lamp according to an embodiment of the present invention.

### DETAILED DESCRIPTION

The above-described purpose, features, and advantages of the present disclosure will become clearer through the following embodiments in conjunction with the attached drawings. The following specific structural and functional descriptions are merely illustrative for the purpose of describing embodiments according to the concept of the present invention, and the embodiments according to the concept of the present invention may be implemented in various forms and should not be construed as limited to embodiments in the specification or the application. Since the embodiments according to the concept of the present disclosure may be variously changed and may have various forms, specific embodiments will be illustrated in the drawings and described in detail in the specification or the application. However, it should be understood that this is not intended to limit the embodiments according to the concept of the present invention to a specific form and includes all changes, equivalents, and substitutions included within the spirit and technical scope of the present invention. The term such as first or second may be used to describe various components, but the components are not limited by the term. The terms are used only for the purpose of distinguishing one component from another, and for example, a first component may be referred to as a second component, and similarly, the second component may also be referred to as the first component without departing from the scope according to the concept of the present disclosure. It should be understood that when a first component is described as being “connected” or “coupled” to a second component, the first component may be directly connected or coupled to the second component, but a third component may also be present therebetween. On the other hand, it should be understood that when a first component is described as being “directly connected” or “directly coupled” to a second component, a third component is not present therebetween. Other expressions for describing the relationship between components, in other words, expressions such as “between” and “directly between” or “adjacent to” and “directly adjacent to” should be construed in the same manner. The terms used in the specification are only used to describe specific embodiments and are not intended to limit the present disclosure. The singular includes the plural unless the context clearly dictates otherwise. In the specification, it should be understood that the term “comprise” or “have” is intended to specify that a stated feature, number, step, operation, component, part, or a combination thereof is present and does not preclude the possibility of the presence or addition of one or more other features, numbers, steps, operations, components, parts, or combinations thereof. Unless defined otherwise, all terms used herein, including technical or scientific terms, have the same meaning as commonly understood by those of ordinary skill in the art to which the present disclosure pertains. The terms defined in a generally used dictionary should be construed as having meanings that coincide with the meanings of the terms from the context of the related technology and are not construed as an ideal or excessively formal meaning unless clearly defined in the specification. Hereinafter, the present disclosure will be described in detail by describing preferred embodiments of the present disclosure with reference to the accompanying drawings. The same reference numerals in each drawing indicate the same member.

In addition, a system refers to a set of components including devices, mechanisms, and units that are organized and interact regularly to perform necessary functions.

In a right-hand traffic area, high beams of a host vehicle cause glare to most oncoming vehicles on a right-hand curved road. Accordingly, the present invention provides a technology for precisely controlling a light-emitting state of a vehicle lamp (high beams) when a right-hand curved road begins at a long distance ahead of the host vehicle in a right-hand traffic area, thereby providing a driver of a host vehicle with maximum visibility and minimizing glare to an opposite lane.

Accordingly, it is possible to minimize unnecessary energy waste, provide maximum illumination to the driver of the host vehicle, and minimize glare to the opposite lane.

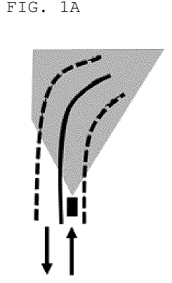

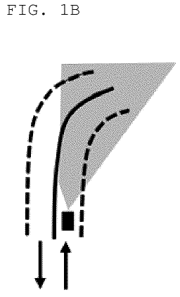

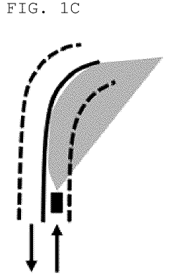

Specifically, FIGS. 1A, 1B and 1C are view illustrating results of controlling a vehicle lamp according to the related art and results of controlling a vehicle lamp according to the present invention.

FIG. 1A illustrates one of results of controlling the vehicle lamp according to the related art, in which a light-emitting state of the vehicle lamp is controlled using a steering angle (steering information) of the driver, and since this cannot respond to a curved road until the host vehicle actually enters the curved road, there is no method of preventing glare to a vehicle (oncoming vehicle) positioned on the curved road of the opposite lane caused by the high beams of the host vehicle.

In addition, FIG. 1B illustrates another one of the results of controlling the vehicle lamp according to the related art, in which the light-emitting state of the vehicle lamp is controlled through analyzed information on a forward lane using forward image data acquired through a camera sensor and the like mounted on the host vehicle, and since this also may not recognize the curved road until the host vehicle is actually positioned just before the curved road, there is no method of preventing glare to the vehicle (oncoming vehicle) positioned on the curved road of the opposite lane caused by the high beams of the host vehicle.

In contrast, FIG. 1C illustrates a result of controlling the vehicle lamp according to the present invention, and when a right boundary line of a lane on which a host vehicle is located is set using forward image data acquired through a camera sensor and the like mounted on the host vehicle and a maximum visibility point on the set right boundary line is recognized, a lighting pattern of the vehicle lamp may be generated based on the recognized maximum visibility point and road surface to control the light-emitting state, thereby minimizing glare to the vehicle (oncoming vehicle) positioned on the curved road of the opposite lane caused by the high beams of the host vehicle even before the host vehicle enters the curved road. Of course, maximum illumination can be provided to the driver of the host vehicle.

In the lamp control system for a vehicle and the method of controlling the same according to the present invention, preemptive response to curvature changes at a long distance, that is, to curved roads occurring at a long distance, is possible, and using the right boundary line of the lane, a quick response to dynamic situations, such as lane changes, can be achieved.

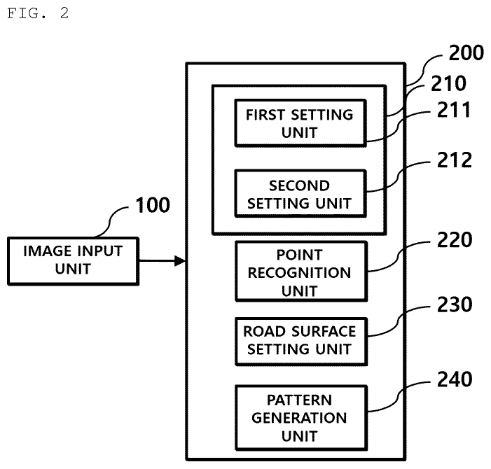

FIG. 2 is an exemplary view illustrating a configuration of a lamp control system for a vehicle according to an embodiment of the present invention, and the lamp control system for a vehicle according to the embodiment of the present invention will be described in detail with reference to FIG. 2.

As illustrated in FIG. 2, the lamp control system for a vehicle according to the embodiment of the present invention includes an image input unit 100 and an image analysis unit 200. Each component is included in a computational processing unit including a CPU to perform operations.

Detailed description of each component will be described below.

The image input unit 100 preferably receives forward image data of the vehicle from a camera sensor and the like mounted on the vehicle. The vehicle forward image data refers to a forward image of the vehicle while traveling and includes various lane line information and roadside structure information. For example, the forward image data of the vehicle includes various lane line information and roadside structure information, such as white lane lines (lane boundary lines for the same direction), yellow lane lines (lane boundary lines for oncoming lanes), blue lane lines (lane boundary lines for bus-only lanes), dotted lines (lane changeable section of a lane available for same-direction travel), solid lines (sections in which lane changes are not possible), double solid lines (sections in which lane changes or parking are not possible), guardrails, medians, streetlights, etc.

The image analysis unit 200 preferably analyzes the forward image data of the vehicle received from the image input unit 100 using a prestored image processing algorithm to generate lighting pattern information for controlling lamps for a vehicle (high beams).

The lamp control unit for a vehicle controls light-emitting states of a left high beam and a right high beam using the lighting pattern information generated by the image analysis unit 200. Specifically, since the camera sensor and the like is typically mounted in a central area of the vehicle (e.g., a rearview mirror, a front central portion of a hood, or the like), the forward image data of the vehicle acquired through these sensors includes both a light-emitting area (range) of the left high beam and a light-emitting area of the right high beam. Accordingly, the lamp control unit for a vehicle receives the generated lighting pattern information and controls a light source matching each (right or left) high beam. Since using lighting pattern information from the forward image data of the vehicle to control each high beam, that is, using a single lighting pattern to identify and control separate lighting pattern information suitable for each high beam corresponds to the conventional ADB technology, detailed descriptions of the control of the light-emitting state of each of the left and right high beams based on a single lighting pattern will be omitted.

The image analysis unit 200 analyzes the forward image data of the vehicle to determine whether the road type on which the host vehicle is traveling begins with a right curved road at a long distance ahead.

In this way, in the determination of whether the right-hand curved road begins at a long distance ahead, when, as a result of analyzing the forward image data of the vehicle, roadside structures, such as guardrails, medians, streetlights, and the like, rather than lane lines, are biased to the right side, or the right curved road begins at a long distance ahead based on map information stored in an in-vehicle navigation system in advance or in real time, it is determined that the right curved road begins at the long distance ahead of the host vehicle.

In this case, a criterion for the long distance is determined based on the current speed of the vehicle, and as the speed increases, the criterion for the long distance becomes farther, and thus the long distance is not limited to a specific separation distance.

In addition, prestored image processing algorithms include various image processing algorithms, such as a Canny edge detection algorithm, a Hough Transform algorithm, a convolutional neural network (CNN), a lane detection algorithm, and the like, and a single algorithm or a combination of two or more algorithms may be used to analyze the forward image data of the vehicle. Since the generation of the lighting pattern information through the analysis of the forward image data of the vehicle corresponds to the conventional ADB technology, detailed descriptions thereof will be omitted.

However, as described above, the present invention includes a boundary line setting unit 210, a point recognition unit 220, a road surface setting unit 230, and a pattern generation unit 240, as illustrated in FIG. 2, to generate lighting pattern information for precise light-emitting control of the high beams suitable for the HD-ADB technology, which is more advanced than the ADB technology.

The boundary line setting unit 210 preferably analyzes the forward image data of the vehicle received from the image input unit 100 using the prestored image processing algorithm to set the right boundary line of the lane.

In this case, the boundary line setting unit 210 may use the result of analyzing the forward image data of the vehicle to determine whether the host vehicle is traveling in the rightmost lane.

That is, the boundary line setting unit 210 may use the result of analyzing the forward image data of the vehicle to determine whether a predetermined object is recognized (extracted) within a predetermined distance from the right side of the host vehicle while traveling.

That is, when a guardrail, a legally stipulated road boundary line, or the like is recognized (extracted) within a predetermined distance from the right side of the host vehicle while traveling, it is determined that the host vehicle is traveling in the rightmost lane. Here, the predetermined objects preferably include guardrails, road boundary lines, and the like, and in addition, various lane line information and roadside structure information, which may be determined to be the rightmost lane, are preferably set as the predetermined objects.

Based on this, the boundary line setting unit 210 includes a first setting unit 211 and a second setting unit 222, as illustrated in FIG. 2.

Specifically, when the host vehicle is traveling in the rightmost lane, the corresponding predetermined object is preferably set as the right boundary line through the first setting unit 211.

Alternatively, preferably, when the host vehicle is not traveling in the rightmost lane, a virtual boundary line is generated on the right outer side of the lane in which the host vehicle is traveling and the generated virtual boundary line is set as the right boundary line through the second setting unit 212.

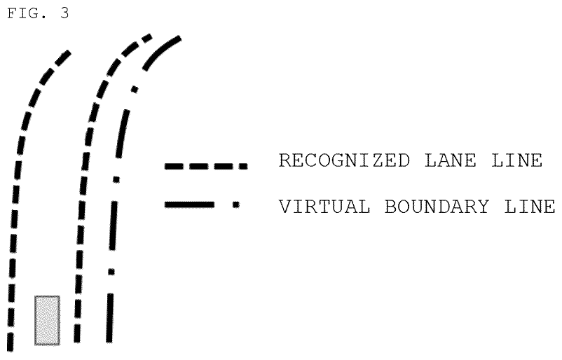

That is, as illustrated in FIG. 3, the second setting unit 212 uses the prestored image processing algorithm to recognize at least one lane line information, which is not set as the predetermined object, without recognizing the predetermined object within the predetermined distance from the right side of the host vehicle, when the lane on which the host vehicle is traveling is not the rightmost lane. Using this, a virtual boundary line is generated at a position spaced a predetermined distance outward from the right side of the recognized lane line (most preferably, the lane line recognized closest to the right side of the host vehicle).

Here, the predetermined distance is preferably set based on the legally stipulated distance between the rightmost lane line and the guardrail or between the rightmost lane line and the road boundary line, but is not specifically limited thereto.

In this way, the image processing algorithm for generating the virtual boundary line may be any algorithm capable of modeling and generating a virtual boundary line based on the recognized lane line, such as a polynomial fitting algorithm, spline interpolation, a lane offset generation algorithm, etc.

The point recognition unit 220 preferably recognizes the maximum visibility point of the right boundary line set by the boundary line setting unit 210. The maximum visibility point refers to the furthest point of the right boundary line that may be recognized within the forward image data of the vehicle, that is, the maximum visible point.

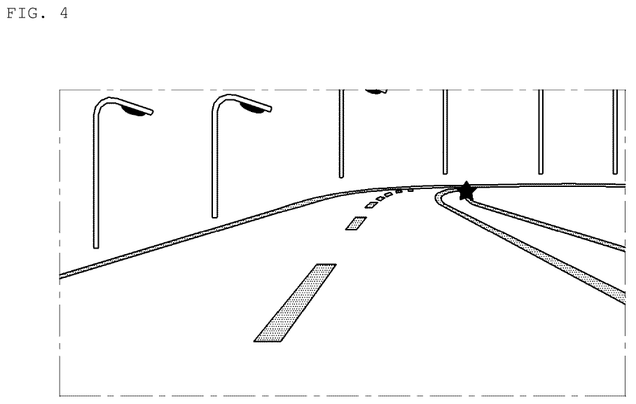

The point recognition unit 220 uses the result of analyzing the forward image data of the vehicle to convert the right boundary line set by the boundary line setting unit 210 into 2D format. Then, using position coordinates of the right boundary line, the maximum point of the right boundary line with respect to a y-axis is preferably recognized as the maximum visibility point. FIG. 4 is an exemplary view illustrating a line drawing of the input forward image data of the vehicle. Referring to FIG. 4, when the host vehicle is traveling in the right lane marked by the dotted line, a road boundary line, which is legally stipulated as the outer right side of the lane in which the host vehicle is traveling, is recognized, and thus the corresponding road boundary line is set as the right boundary line. Accordingly, the point recognition unit 220 recognizes the farthest point of the right boundary line, which is marked by an asterisk in FIG. 4, as the maximum visibility point. The maximum visibility point may generally be a vanishing point, but in the present invention, is construed as a point where the curvature of the right boundary line changes because a right curved road begins.

That is, it is common for a vehicle to travel forward, and since drivers consider glare to an oncoming lane caused by high beams of a host vehicle when driving forward, the farthest point ahead along the right boundary line is recognized as the maximum visibility point.

To this end, the result of analyzing the forward image data of the vehicle include not only various lane line information and roadside structure information, but also the reliability of the corresponding information and the maximum visibility point of the corresponding information.

Preferably, the road surface setting unit 230 uses the result of analyzing the forward image data of the vehicle to set a road surface boundary line. In the field of image processing, since the analysis of the forward image data of the vehicle to set the road surface boundary line, that is, a roadway, on which the vehicle is traveling is a common technique, detailed descriptions thereof will be omitted.

The pattern generation unit 240 preferably generates lighting pattern information of the vehicle lamp using the set right boundary line, the recognized maximum visibility point, and the set road surface boundary line.

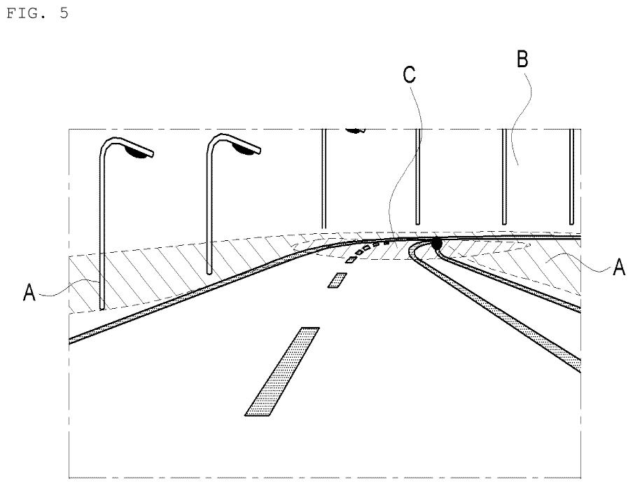

The pattern generation unit 240 generates lighting pattern information including at least three control zones, and referring to FIG. 5, the pattern generation unit includes a first control zone A, a second control zone B, and a third control zone C. Specifically, the first control zone A is set to an area from the road surface boundary line to a predetermined height. That is, since the first control zone A is set to an area from the road surface boundary line to a predetermined height, as illustrated in FIG. 5, the road surface boundary line gradually rises due to perspective effects in the image data as distance increases from the host vehicle, and thus the road surface corresponding to the farthest distance from the host vehicle is set to the narrowest width.

Here, the predetermined height is preferably set in consideration of a height of the host vehicle, and for example, preferably, for general passenger vehicles such as a sedan, a hatchback, and the like, the predetermined height is set to about 1.1 to 1.3 m from the ground, for SUVs and crossovers, the predetermined height is set to about 1.2 to 1.5 m, and for pickup trucks and large SUVs, the predetermined height is set to about 1.4 to 1.7 m, but the present invention is not necessarily limited thereto.

In addition, the second control zone B is set to an area from the first control zone A to an end point along the y-axis. That is, as illustrated in FIG. 5, all areas exceeding the predetermined height with respect to the road surface boundary line are set as the second control zone B.

Lastly, the third control zone C is set to a predetermined range surrounding the recognized maximum visibility point. Here, the predetermined range is set in consideration of factors such as the specifications of each light source constituting high beams, the speed of the host vehicle, and the like, and at high speeds, a wider predetermined range is preferably set, and the predetermined range around the maximum visibility point is not limited. However, in the present invention, the third control zone C is most preferably set around the maximum visibility point, which is the farthest visibility point of the right boundary line set with respect to the host vehicle.

The pattern generation unit 240 of the present invention preferably generates light source control information that best corresponds to the generated lighting pattern information.

To this end, control information of at least one of the light emitting position and light intensity of each light source for each control zone A, B, or C is preferably generated, matched with the lighting pattern information, and transmitted.

Specifically, the pattern generation unit 240 preferably generates control information to turn on or off a light source corresponding to the first control zone A depending on the presence of an oncoming vehicle with respect to the first control zone A and matches the control information with the lighting pattern information.

The presence of the oncoming vehicle can be easily determined using the result of analyzing the forward image data of the vehicle, and preferably, the light source is turned off when the oncoming vehicle is present, and the light source remains turned on or a gradient that darkens as the vehicle approaches the second control zone B is applied when no oncoming vehicle is present. In this case, the gradient application can minimize unnecessary energy waste by illuminating adjacent roads that needs to be visible to the driver of the host vehicle with a relatively high luminous intensity and illuminating roads of lesser importance with a relatively low luminous intensity.

In addition, for the second control zone B, control information to turn off the light source corresponding to the second control zone B is preferably generated and matched with the lighting pattern information.

This is an area in which the driver of the host vehicle does not need to recognize while traveling, and by turning off the light sources to prevent unnecessary glare to drivers of vehicles positioned on the opposite lane, it is possible to minimize unnecessary energy waste and minimize glare to other vehicles.

In addition, for the third control zone C, by applying gradient such that the luminous intensity of at least one light source corresponding to the maximum visibility point among the light sources corresponding to the third control zone C is the highest, and the luminous intensity gradually decreases toward the periphery compared to that of the light source at the maximum visibility point, control information is preferably generated and matched with the lighting pattern information. That is, it is preferably to set the maximum visibility point within the third control zone C to be the brightest and gradually darken toward the periphery.

In this case, the light sources corresponding to the third control zone C may be controlled at the same luminous intensity corresponding to the maximum visibility point without applying gradient adjustment, but in this case, since glare may be caused to the driver of a vehicle positioned on the opposite lane (e.g., a vehicle exiting a right hand curved road starting from a distant point ahead of the host vehicle), through gradation turn-off, the glare to other vehicles can be minimized, and unnecessary energy waste can also be minimized.

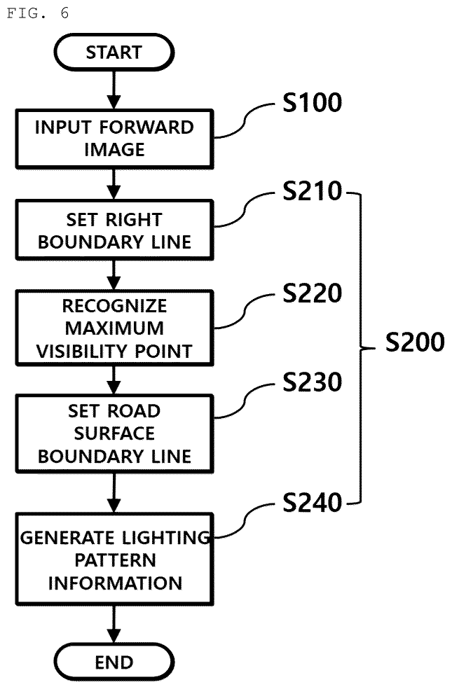

FIG. 6 is an exemplary flowchart illustrating a method of controlling a vehicle lamp according to an embodiment of the present invention, and the method of controlling a vehicle lamp according to the embodiment of the present invention includes an image input operation S100 and an image analysis operation S200. Each operation is performed using a lamp control system for a vehicle, which is implemented by a computational processing unit including a CPU or the like.

Detailed descriptions of each operation will be described in detail below.

The image input operation S100 includes receiving, by the image input unit 100, forward image data of the vehicle from a camera sensor and the like mounted on the vehicle. The vehicle forward image data refers to a forward image of the vehicle while traveling and includes various lane line information and roadside structure information. For example, the forward image data of the vehicle includes various lane line information and roadside structure information, such as white lane lines (lane boundary lines for the same direction), yellow lane lines (lane boundary lines for oncoming lanes), blue lane lines (lane boundary lines for bus-only lanes), dotted lines (lane changeable section of a lane available for same-direction travel), solid lines (sections in which lane changes are not possible), double solid lines (sections in which lane changes or parking are not possible), guardrails, medians, streetlights, etc.

The image analysis operation S200 includes analyzing, by the image analysis unit 200, the forward image data of the vehicle received through the image input operation S100 using the prestored image processing algorithm to generate lighting pattern information to control the vehicle lamp (high beams).

The lamp control unit for a vehicle controls light-emitting states of a left high beam and a right high beam using the lighting pattern information generated through the image analysis operation S200. Specifically, since the camera sensor and the like is typically mounted in a central area of the vehicle (e.g., a rearview mirror, a front central portion of a hood, or the like), the forward image data of the vehicle acquired through these sensors includes both a light-emitting area (range) of the left high beam and a light-emitting area of the right high beam. Accordingly, the lamp control unit for a vehicle receives the generated lighting pattern information and controls a light source matching each (right or left) high beam. Since using lighting pattern information from the forward image data of the vehicle to control each high beam, that is, using a single lighting pattern to identify and control separate lighting pattern information suitable for each high beam corresponds to the conventional ADB technology, detailed descriptions of the control of the light-emitting state of each of the left and right high beams based on a single lighting pattern will be omitted.

The image analysis operation S200 includes analyzing the forward image data of the vehicle to determine whether the road type on which the host vehicle is traveling begins with a right curved road at a long distance ahead of the host vehicle.

In this way, in the determination of whether the right-hand curved road begins at a long distance ahead, when, as a result of analyzing the forward image data of the vehicle, roadside structures, such as guardrails, medians, streetlights, and the like, rather than lane lines, are biased to the right side, or the right curved road begins at a long distance ahead based on map information stored in an in-vehicle navigation system in advance or in real time, it is determined that the right curved road begins at the long distance ahead of the host vehicle.

In this case, a criterion for the long distance is determined based on the current speed of the vehicle, and as the speed increases, the criterion for the long distance becomes farther, and thus the long distance is not limited to a specific separation distance.

In addition, prestored image processing algorithms include various image processing algorithms, such as a Canny edge detection algorithm, a Hough Transform algorithm, a convolutional neural network (CNN), a lane detection algorithm, and the like, and a single algorithm or a combination of two or more algorithms may be used to analyze the forward image data of the vehicle. Since the generation of the lighting pattern information through the analysis of the forward image data of the vehicle corresponds to the conventional ADB technology, detailed descriptions thereof will be omitted.

However, as described above, the present invention includes a boundary line setting operation S210, a point recognition operation S220, a road surface setting operation S230, and a pattern generation operation S240, as illustrated in FIG. 6, to generate lighting pattern information for precise light-emitting control of the high beams suitable for the HD-ADB technology, which is more advanced than the ADB technology.

The boundary line setting operation S210 includes analyzing the received forward image data of the vehicle using the prestored image processing algorithm to set the right boundary line of the lane. In this case, the boundary line setting operation S210 may include using the result of analyzing the forward image data of the vehicle to determine whether the host vehicle is traveling in the rightmost lane.

That is, the boundary line setting operation 210 may include using the result of analyzing the forward image data of the vehicle to determine whether a predetermined object is recognized (extracted) within a predetermined distance from the right side of the host vehicle while traveling and determining whether the host vehicle is traveling on the rightmost lane.

That is, when a guardrail, a legally stipulated road boundary line, or the like is recognized (extracted) within a predetermined distance from the right side of the host vehicle while driving, it is determined that the host vehicle is traveling in the rightmost lane. Here, the predetermined objects preferably include guardrails, road boundary lines, and the like, and in addition, various lane line information and roadside structure information, which may be determined to be the rightmost lane, are set as the predetermined objects.

Based on this, in the boundary line setting operation S210, when the host vehicle is traveling in the rightmost lane, the corresponding predetermined object is set as the right boundary line.

Conversely, when the host vehicle is not traveling in the rightmost lane, a virtual boundary line is generated outside the right side of the traveling lane, and the generated virtual boundary line is set as the right boundary line.

That is, using the prestored image processing algorithm, as illustrated in FIG. 3, when the host vehicle is not traveling in the rightmost lane, no predetermined object is recognized within the predetermined distance from the right side of the host vehicle, and at least one lane line not set as the predetermined object is recognized. Using this, a virtual boundary line is generated at a position spaced a predetermined distance outward from the right side of the recognized lane line (most preferably, the lane line recognized closest to the right side of the host vehicle).

Here, the predetermined distance is preferably set based on the legally stipulated distance between the rightmost lane line and the guardrail or between the rightmost lane line and the road boundary line, but is not specifically limited thereto.

In this way, the image processing algorithm for generating the virtual boundary line may be any algorithm capable of modeling and generating a virtual boundary line based on the recognized lane line, such as a polynomial fitting algorithm, spline interpolation, a lane offset generation algorithm, etc.

In the point recognition operation S220, the maximum visibility point of the right boundary line set in the boundary line setting operation S210 is recognized. In this case, the maximum visibility point refers to the farthest point of the right boundary line that may be recognized within the forward image data of the vehicle, that is, the maximum visibility point.

The point recognition operation S220 includes using the result of analyzing the forward image data of the vehicle to convert the right boundary line set in the boundary line setting operation S210 into 2D format. Then, using position coordinates of the right boundary line, the maximum point of the right boundary line along the y-axis is recognized as the maximum visibility point.

FIG. 4 is an exemplary view illustrating a line drawing of the input forward image data of the vehicle. Referring to FIG. 4, when the host vehicle is traveling in the right lane marked by the dotted line, a road boundary line, which is legally stipulated as the outer right side of the lane in which the host vehicle is traveling, is recognized, and thus the corresponding road boundary line is set as the right boundary line. Accordingly, the point recognition operation S220 includes recognizing the farthest point of the right boundary line, which is marked by an asterisk in FIG. 4, as the maximum visibility point. The maximum visibility point may generally be a vanishing point, but in the present invention, is construed as a point where the curvature of the right boundary line changes because a right curved road begins.

That is, it is common for a vehicle to travel forward, and since drivers consider glare to an oncoming lane caused by high beams of a host vehicle when driving forward, the farthest point ahead along the right boundary line is recognized as the maximum visibility point.

To this end, the result of analyzing the forward image data of the vehicle include not only various lane line information and roadside structure information, but also the reliability of the corresponding information and the maximum visibility point of the corresponding information.

The road surface setting operation S230 includes using the result of analyzing the forward image data of the vehicle to set a road surface boundary line. In the field of image processing, since the analysis of the forward image data of the vehicle to set the road surface boundary line, that is, a roadway, on which the vehicle is traveling is a common technique, detailed descriptions thereof will be omitted.

The pattern generation operation S240 includes generating lighting pattern information of the vehicle lamp using the set right boundary line, the recognized maximum visibility point, and the set road surface boundary line.

The pattern generation operation S240 includes generating lighting pattern information including at least three control zones, and referring to FIG. 5, the first control zone A, the second control zone B, and the third control zone C are provided. Specifically, the first control zone A is set to a predetermined height with respect to the road surface boundary line. That is, since the first control zone A is set to an area from the road surface boundary line to a predetermined height, as illustrated in FIG. 5, the road surface boundary line gradually rises due to perspective effects in the image data as distance increases from the host vehicle, and thus the road surface corresponding to the farthest distance from the host vehicle is set to the narrowest width.

Here, the predetermined height is preferably set in consideration of a height of the host vehicle, and for example, preferably, for general passenger vehicles such as a sedan, a hatchback, and the like, the predetermined height is set to about 1.1 to 1.3 m from the ground, for SUVs and crossovers, the predetermined height is set to about 1.2 to 1.5 m, and for pickup trucks and large SUVs, the predetermined height is set to about 1.4 to 1.7 m, but the present invention is not necessarily limited thereto.

In addition, the second control zone B is set to an end point along the y-axis of the first control zone A. That is, as illustrated in FIG. 5, all areas exceeding the predetermined height with respect to the road surface boundary line are set as the second control zone B.

Lastly, the third control zone C is set to a predetermined range surrounding the recognized maximum visibility point. Here, the predetermined range is set in consideration of factors such as the specifications of each light source constituting high beams, the speed of the host vehicle, and the like, and at high speeds, a wider predetermined range is preferably set, and the predetermined range around the maximum visibility point is not limited. However, in the present invention, the third control zone C is most preferably set around the maximum visibility point, which is the farthest visibility point of the right boundary line set with respect to the host vehicle.

The present invention also generates control information of the light source that is most preferable to the generated lighting pattern information. To this end, the pattern generation operation S240 includes generating control information of at least one of the light-emitting position and light intensity of each light source for each control zone A, B, and C, matching the information with the lighting pattern information, and transmitting the matched information.

Specifically, the pattern generation operation S240 includes generating control information to turn on or off a light source corresponding to the first control zone A depending on the presence of an oncoming vehicle with respect to the first control zone A, matching the control information with the lighting pattern information, and transmitting the matched information.

The presence of the oncoming vehicle can be easily determined using the result of analyzing the forward image data of the vehicle, and the light source is turned off when the oncoming vehicle is present, and the light source remains turned on or a gradient control that darkens as the vehicle approaches the second control zone B is applied when no oncoming vehicle is present. In this case, the gradient control application can minimize unnecessary energy waste by illuminating adjacent roads that needs to be visible to the driver of the host vehicle with a relatively high luminous intensity and illuminating roads of lesser importance with a relatively low luminous intensity.

In addition, for the second control zone B, control information to turn off the light source corresponding to the second control zone B is generated, matched with the lighting pattern information, and transmitted.

This is an area in which the driver of the host vehicle does not need to recognize while traveling, and by turning off the light sources to prevent unnecessary glare to drivers of vehicles positioned on the opposite lane, it is possible to minimize unnecessary energy waste and minimize glare to other vehicles.

In addition, for the third control zone C, by applying gradient control such that the luminous intensity of at least one light source corresponding to the maximum visibility point among the light sources corresponding to the third control zone C is the highest, and the luminous intensity gradually decreases toward the periphery compared to that of the light source at the maximum visibility point, control information is generated, matched with the lighting pattern information, and transmitted. That is, it is to set the maximum visibility point within the third control zone C to be the brightest and gradually darken toward the periphery.

In this case, the light sources corresponding to the third control zone C may be controlled at the same luminous intensity corresponding to the maximum visibility point without applying gradient control, but in this case, since glare may be caused to the driver of a vehicle positioned on the opposite lane (e.g., a vehicle exiting a right hand curved road starting from a distant point ahead of the host vehicle), through gradation control, the glare to other vehicles can be minimized, and unnecessary energy waste can also be minimized.

The present invention may be implemented as computer-readable codes on a medium on which a program is recorded. The computer-readable medium includes any type of recording device in which data that may be read by a computer system are stored. Examples of the computer-readable media include a hard disk drive (HDD), a solid state disk (SSD), a silicon disk drive (SDD), a read only memory (ROM), a random access memory (RAM), a CD-ROM, a magnetic tape, a floppy disk, an optical data storage device, and the like, and also include one implemented in the form of carrier waves (e.g., transmission via Internet). In addition, the computer may include the lamp control system for a vehicle and the method of controlling the same according to the present invention.

According to the lamp control system for a vehicle and the method of controlling the same according to the present invention, by precisely controlling the light-emitting state of the lamp (high beams) for a vehicle when the right-hand curved road begins at a long distance ahead of the host vehicle in the right-hand traffic area, it is possible to provide maximum illumination to the driver of the host vehicle and at the same time, minimize glare to the vehicle (oncoming vehicle) positioned on the curved road of the opposite lane due to the high beams of the host vehicle.

In particular, by dividing the front area of the host vehicle in greater detail to generate lighting pattern information, precise lighting control suitable for HD-ADB technology can be possible.

Although the exemplary embodiments of the present disclosure have been described above, the embodiments disclosed in the present disclosure are not intended to limit the technical spirit of the present disclosure but are only for description. Accordingly, the technical spirit of the present disclosure includes not only each disclosed embodiment, but also a combination of the disclosed embodiments, and furthermore, the scope of the technical spirit of the present disclosure is not limited by these embodiments. In addition, those skilled in the art to which the present disclosure pertains can variously change and modify the present disclosure without departing from the spirit and scope of the appended claims, and all such appropriate changes and modifications should be regarded as belonging to the scope of the present disclosure as equivalents.

### DESCRIPTION OF REFERENCE NUMERALS

100: image input unit
200: image analysis unit
210: boundary line setting unit
211: first setting unit
212: second setting unit
220: point recognition unit
230: road surface setting unit
240: pattern generation unit

What is claimed is:

1. A lamp control system for a vehicle, comprising:
an image input unit configured to receive forward image data of the vehicle from a camera sensor; and
an image analysis unit configured to analyze the forward image data of the vehicle using an image processing algorithm and, when a determined road type begins with a right curved road at a long distance ahead of the vehicle, generate lighting pattern information to control a vehicle lamp,
wherein the vehicle lamp includes a plurality of light sources, and each of the light sources has at least one of a light-emitting position and light intensity controlled according to the lighting pattern information.

2. The lamp control system of claim 1, wherein the image analysis unit includes:
a boundary line setting unit configured to analyze the forward image data of the vehicle to set a right boundary line of a lane;
a point recognition unit configured to recognize a maximum visibility point of the set right boundary line;
a road surface setting unit configured to analyze the forward image data of the vehicle to set a road surface boundary line; and
a pattern generation unit configured to generate the lighting pattern information using the right boundary line, the maximum visibility point, and the road surface boundary line.

3. The lamp control system of claim 2, wherein the boundary line setting unit includes:
a first setting unit configured to analyze the forward image data of the vehicle and, when a predetermined object is recognized, set the corresponding predetermined object as the right boundary line; and
a second setting unit configured to analyze the forward image data of the vehicle and, when the predetermined object is not recognized, generate a virtual boundary line outward from a right side of the recognized lane line and set the generated virtual boundary line as the right boundary line.

4. The lamp control system of claim 2, wherein the point recognition unit is configured to recognize a maximum point of the right boundary line along a y-axis as the maximum visibility point using position coordinates of the right boundary line.

5. The lamp control system of claim 2, wherein the pattern generation unit is configured to:
set an area from the road surface boundary line to a predetermined height as a first control zone;
set an area from the first control zone to an end point along a y-axis as a second control zone;
set a predetermined range around the maximum visibility point as a third control zone; and
generate the lighting pattern information to control at least one of light-emitting positions and luminous intensities of each light source corresponding to each control zone.

6. The lamp control system of claim 5, wherein the pattern generation unit is configured to:
generate the lighting pattern information so that the corresponding light source is selectively turned on or off depending on the presence of an oncoming vehicle with respect to the first control zone;
generate the lighting pattern information so that the corresponding light source is turned off with respect to the second control zone; and
generate the lighting pattern information so that a luminous intensity of the light source corresponding to the maximum visibility point is highest and gradually decreases toward a periphery compared to the luminous intensity of the maximum visibility point with respect to the third control zone.

7. A method of controlling a vehicle lamp, in which each operation is performed by a computational processing unit, the method comprising:
an image input operation of receiving forward image data of a vehicle from a camera sensor; and
an image analysis operation of analyzing the forward image data of the vehicle received in the image input operation using an image processing algorithm and, when a determined road type begins with a right curved road at a long distance ahead of the vehicle, generating lighting pattern information to control the vehicle lamp.

8. The method of claim 7, wherein the image analysis operation includes:
when a determined road type begins with a right curved road at a long distance ahead of the vehicle as a result of analyzing the forward image data of the vehicle received in the image input operation,
a boundary line setting operation of analyzing the forward image data of the vehicle to set a right boundary line of a lane;
a point recognition operation of recognizing a maximum visibility point of the right boundary line set in the boundary line setting operation;
a road surface setting operation of setting a road surface boundary line by analyzing the forward image data of the vehicle received in the image input operation; and
a pattern generation operation of generating the lighting pattern information using the right boundary line, the maximum visibility point, and the road surface boundary line.

9. The method of claim 8, wherein the boundary line setting operation includes analyzing the forward image data of the vehicle and, when a predetermined object is recognized, setting the corresponding predetermined object as the right boundary line.

10. The method of claim 8, wherein the boundary line setting operation includes analyzing the forward image data of the vehicle and, when a predetermined object is not recognized, generating a virtual boundary line outward from a right side of the recognized lane line, and setting the generated virtual boundary line as the right boundary line.

11. The method of claim 8, wherein the point recognition operation includes recognizing a maximum point of the right boundary line along a y-axis as the maximum visibility point using position coordinates of the right boundary line set in the boundary line setting operation.

12. The method of claim 8, wherein the image generation operation includes:
a first generation operation of setting an area from the road surface boundary line to a predetermined height as a first control zone;
a second generation operation of setting an area from the first control zone to an end point along a y-axis as a second control zone;
a third generation operation of setting a predetermined range around the maximum visibility point as a third control zone,
the vehicle lamp includes a plurality of light sources, and
each light source corresponding to each control zone has at least one of a light-emitting position and light intensity controlled according to the lighting pattern information.

13. The method of claim 12, wherein the image generation operation includes:
generating the lighting pattern information so that the corresponding light source is selectively turned on or off depending on the presence of an oncoming vehicle with respect to the first control zone;
generating the lighting pattern information so that the corresponding light source is turned off with respect to the second control zone; and
generating the lighting pattern information so that a luminous intensity of the light source corresponding to the maximum visibility point is highest and gradually decreases toward a periphery compared to the luminous intensity of the maximum visibility point with respect to the third control zone.
